(19) United States
(12) Patent Application Publication
(10) Pub. No.: US 2013/0315142 A1
(43) Pub. Date: Nov. 28, 2013

(54) TERMINAL DEVICE AND METHOD FOR REDUCING INTERFERENCE IN A DEVICE

(71) Applicant: Huawei Technologies Co., Ltd., Shenzhen (CN)

(72) Inventors: Wen Gao, Shenzhen (CN); Yi Guo, Shenzhen (CN)

(21) Appl. No.: 13/935,973

(22) Filed: Jul. 5, 2013

Related U.S. Application Data
(63) Continuation of application No. PCT/CN2012/070138, filed on Jan. 9, 2012.

(30) Foreign Application Priority Data
Jan. 7, 2011 (CN) 201110002792.2

(51) Int. Cl. H04W 24/02

(52) U.S. Cl. CPC H04W 24/02
USPC 370/328

(57) ABSTRACT

Embodiments of the present invention disclose a terminal device and a method thereof for reducing interference in a device, which belong to the field of interference processing. The method includes: receiving a control signaling for interference processing sent by a base station; and according to the control signaling, stopping a related operation within a non-scheduling period of a communication mode corresponding to the control signaling. The terminal device includes: a receiving module, and a stopping module. This reduces the interference to the other communication modes due to the communication mode corresponding to the control signaling within the non-scheduling period, and thus reduces interference in the terminal device within the non-scheduling period.

### CROSS-REFERENCE TO RELATED APPLICATIONS

This application is a continuation of International Application No. PCT/CN2012/070138, filed on Jan. 9, 2012, which claims priority to Chinese Patent Application No. 201110002792.2, filed on Jan. 7, 2011, both of which are hereby incorporated by reference in their entireties.

### FIELD OF TECHNOLOGY

The present invention relates to the field of interference processing, and in particular, to a terminal device and a method for reducing interference in a device.

### BACKGROUND

In a communication system, a frequency spectrum is divided into different frequency ranges, and there are adjacent frequency ranges which are occupied by different communication modes respectively. When a terminal device adopts different communication modes of the frequency ranges which are adjacent to each other for communication, interference in the terminal device occurs.

In order to solve the problem of interference in the terminal device, a TDM (Time-division multiplexing, time-division multiplexing) scheme has been proposed currently, that is, the communication systems with adjacent frequency ranges carry out communication in time-division. The TDM scheme divides a present communication mode into a non-scheduling period and a scheduling period by using a DRX (Discontinuous Reception, discontinuous reception) mechanism of a system. Taking an LTE (Long Term Evolution, long term evolution) system as an example, the scheduling period refers to a time period when an on duration timer and an inactivity timer (inactivity timer) are running, while the non-scheduling period refers to a time period when the on duration timer and a DRX inactivity timer are not running. In the present communication mode, data is transmitted within the scheduling period, while in other communication modes, data is transmitted within the non-scheduling period of the present communication mode, and thus the problem of interference in the terminal device when the system coexists with other communication modes can be solved.

However, many systems still can carry out some data transmission operations within the non-scheduling period, for example, the LTE system can conduct operations such as data retransmission and scheduling request transmission within the non-scheduling period, which also can cause interference on the other communication modes. There are none corresponding solutions in the prior art to deal with interference in the terminal device.

### SUMMARY

In order to solve the problem of interference in a device within a non-scheduling period, embodiments of the present invention provide a terminal device and a method for reducing interference in the terminal device. The technical solutions are described as follows.

A method for reducing interference in a device, comprising:

receiving a control signaling for interference processing sent by a base station; and

according to the control signaling, stopping a related operation within a non-scheduling period of a communication mode corresponding to the control signaling.

A terminal device, comprising:

a receiving module, configured to receive a control signaling for interference processing sent by a base station; and

a stopping module, configured to, according to the control signaling, stop a related operation within a non-scheduling period of a communication mode corresponding to the control signaling.

The technical solutions of embodiments of the present invention have the following advantages:

Other communication modes are enabled to carry out data transmission within the non-scheduling period of the communication mode corresponding to the control signaling, by way of stopping by the terminal device the related operation within the non-scheduling period of the communication mode corresponding to the control signaling according to the control signaling for interference processing sent by the base station. This reduces the interference to the other communication modes due to the communication mode corresponding to the control signaling within the non-scheduling period, and thus reduces the interference in the terminal device within the non-scheduling period.

### BRIEF DESCRIPTION OF THE DRAWINGS

To make the technical solutions of the present invention more clearly, the following briefly describes the accompanying drawings needed for describing the embodiments or the prior art. Obviously, the accompanying drawings in the following description merely show some embodiments of the present invention, and persons skilled in the art can derive other drawings from these drawings without creative efforts.

FIG. 1 is a flow chart of a method for reducing interference in a device according to Embodiment 1 of the present invention;

FIG. 2 is a flow chart of a method for reducing interference in a device according to Embodiment 2 of the present invention;

FIG. 3 is a schematic structural diagram of a terminal device according to Embodiment 3 of the present invention;

FIG. 4 is another schematic structural diagram of the terminal device according to Embodiment 3 of the present invention;

FIG. 5 is a flow chart of a method for switching frequency according to Embodiment 4 of the present invention; and

FIG. 6 is a schematic structural diagram of a base station according to Embodiment 5 of the present invention.

### DESCRIPTION OF EMBODIMENTS

In order to make objectives, technical solutions, and advantages of the present invention clearer, embodiments of the present invention are further described below in detail with reference to the accompanying drawings.

### Embodiment 1

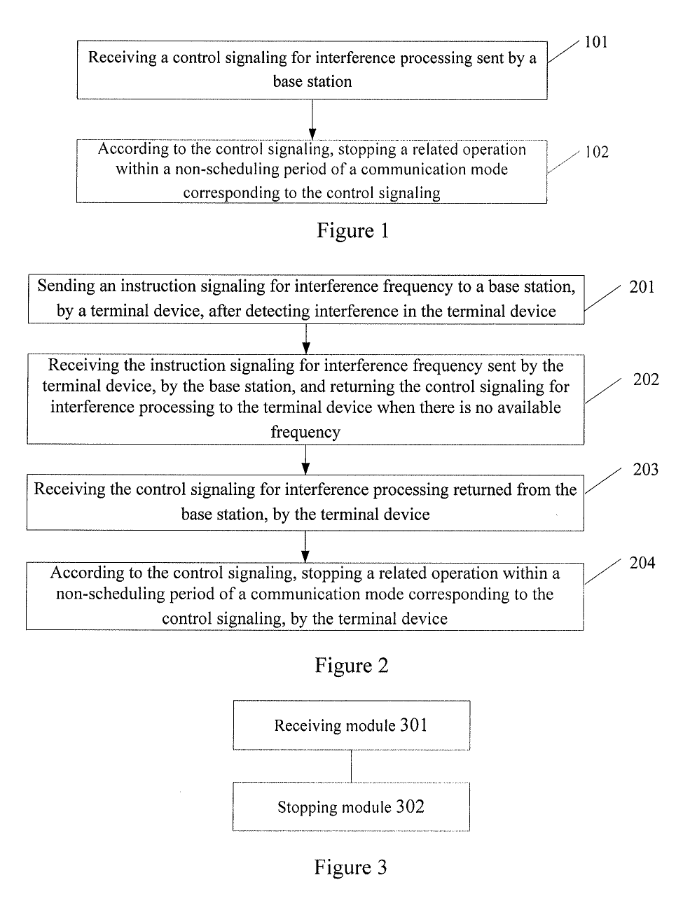

Referring to FIG. 1, this embodiment provides a method for reducing interference in a device, and for a terminal device, the method includes:

101: receiving a control signaling for interference processing sent by a base station; and

102: according to the control signaling, stopping a related operation within a non-scheduling period of a communication mode corresponding to the control signaling.

Wherein, the communication mode includes but is not limited to: LTE, Blue Tooth, ZigBee (ZigBee), WiFi (Wireless Fidelity, wireless fidelity), GSM (Global System for Mobile Communications, global system for mobile communications) and etc.

This embodiment enables other communication modes to carry out data transmission within the non-scheduling period of the communication mode corresponding to the control signaling, by way of stopping by the terminal device the related operation within the non-scheduling period of the communication mode corresponding to the control signaling according to the control signaling for interference processing sent by the base station. This reduces the interference to the other communication modes due to the communication mode corresponding to the control signaling within the non-scheduling period, and thus reduces the interference in the terminal device within the non-scheduling period.

### Embodiment 2

This embodiment is modified on the basis of Embodiment 1. Referring to FIG. 2, this embodiment provides a method for reducing interference in a device, including:

201: sending an instruction signaling for interference frequency to a base station, by a terminal device, after detecting interference in the terminal device;

wherein, the terminal device includes but is not limited to a UE (User Equipment, user equipment).

Wherein, the instruction signaling for interference frequency can include an available frequency and an unavailable frequency. And the instruction signaling for interference frequency may further include a reason for unavailability of a unavailable frequency, such as a reason for the influence of LTE on the BT (Blue Tooth, blue tooth) or WiFi (Wireless Fidelity, wireless fidelity). Wherein, the reason for unavailability can be represented by numbering the scene influenced by the system, for example, the influence of LTE on the BT is numbered as 1, the influence of LTE on the WiFi is numbered as 2, and so on. In addition, the instruction signaling for interference frequency can be an RRC (Radio Resource Control, radio resource control) signaling, a MAC (Media Access Control, media access control) layer signaling, or a PHY (physical, physical layer) signaling.

202: receiving the instruction signaling for interference frequency sent by the terminal device, by the base station, and returning the control signaling for interference processing to the terminal device when there is no available frequency.

Wherein, the control signaling can in particular be a TDM indication. The control signaling can carry no parameter, and also can carry a parameter such as a stopping operation type or a logical channel priority.

Further, if there is an available frequency, the base station can indicate the terminal device to switch to a certain available frequency. Such an FDM (Frequency Division Multiplexing, frequency division multiplexing) method can avoid interference between different systems.

203: receiving the control signaling for interference processing returned from the base station, by the terminal device; and

204: according to the control signaling, stopping a related operation within a non-scheduling period of a communication mode corresponding to the control signaling, by the terminal device.

Wherein, the communication mode corresponding to the control signaling includes a non-scheduling period and a scheduling period, which can be achieved by the DRX mechanism. The communication mode corresponding to the control signaling takes an LTE system as an example, the scheduling period refers to a time period when an on duration timer and an inactivity timer (inactivity timer) are running, while the non-scheduling period refers to a time period when the on duration timer and a DRX inactivity timer are not running. The terminal device can receive a scheduling signaling of PDCCH (Physical Downlink Control Channel, physical downlink control channel) from the base station within the scheduling period and a wake-up time period of the non-scheduling period.

Particularly, this step can be carried out in the following five ways:

204a) according to the control signaling, stopping an uplink downlink retransmission operation within the non-scheduling period of the communication mode corresponding to the control signaling;

In particular, according to the control signaling, stopping a DRX retransmission timer of the communication mode corresponding to the control signaling, and clearing an HARQ (Hybrid Automatic Repeat Request, hybrid automatic repeat request) buffer area of the communication mode corresponding to the control signaling, and thus stopping the uplink downlink retransmission operation within the non-scheduling period of the communication mode corresponding to the control signaling.

This step is applied for a case where the control signaling doesn't carry any parameter, and the terminal device carries out the stopping operation by default.

204b) according to the control signaling, stopping an SR (Scheduling Request, scheduling request) triggering operation within the non-scheduling period of the communication mode corresponding to the control signaling:

This step is applied for a case where the control signaling doesn't carry any parameter, and the terminal device carries out the stopping operation by default.

204c): according to the control signaling, stopping an SPS (Semi Persistent Scheduling, semi persistent scheduling) data transmission operation within the non-scheduling period of the communication mode corresponding to the control signaling;

This step is applied for a case where the control signaling doesn't carry any parameter, and the terminal device carries out the stopping operations by default.

204d) according to the stopping operation type carried by the control signaling, stopping an operation corresponding to the stopping operation type within the non-scheduling period of the communication mode corresponding to the control signaling; alternatively, according to the control signaling, a subsequent operation instruction carrying a stopping operation type, stopping an operation corresponding to the stopping operation type within the non-scheduling period of the communication mode corresponding to the control signaling;

Wherein, the stopping operation type includes but is not limited to: the uplink downlink retransmission operation, the SR triggering operation, or the SPS data transmission operation.

204e) according to an SR triggering condition carried by the control signaling, stopping an SR triggering operation in nonconformity with the SR triggering condition within the non-scheduling period of the communication mode corresponding to the control signaling; alternatively, according to the control signaling, a subsequent operation instruction carrying an SR triggering condition, stopping an SR triggering operation in nonconformity with the SR triggering condition within the non-scheduling period of the communication mode corresponding to the control signaling.

Wherein, the SR triggering condition may be a logical channel priority, a specific service or service type, or radio bearer and etc., and this embodiment is not limited thereto. Particularly, when the SR triggering condition is the logical channel priority, an SR triggering operation of the data with a priority less than the logical channel priority is stopped, and an SR triggering operation of the data with a priority equal to or higher than the logical channel priority is carried out; when the SR triggering condition is the specific service or service type or radio bearer, an SR triggering operation of the specific service or service type or radio bearer is carried out, SR triggering operations of other services or other service types or other radio bearers are stopped; alternatively, the SR triggering operation of the specific service or service type or radio bearer is stopped, and the SR triggering operations of the other services or other service types or other radio bearers are carried out.

This step can prevent a scheduling request from being triggered by some less important data. Further, the data in conformity with the SR triggering condition can trigger the SR.

This embodiment enables other communication modes to carry out data transmission within the non-scheduling period of the communication mode corresponding to the control signaling, by way of stopping by the terminal device a related operation, such as the uplink downlink retransmission operation, the SR triggering operation, the SPS data transmission operation, or the SR triggering operation in nonconformity with the SR triggering condition within the non-scheduling period of the communication mode corresponding to the control signaling according to the control signaling for interference processing sent by the base station. This reduces the interference to the other communication modes due to the communication mode corresponding to the control signaling within the non-scheduling period, and thus reduces interference in the terminal device within the non-scheduling period.

### Embodiment 3

Referring to FIG. 3, this embodiment provides a terminal device, which belongs to the same concept with the terminal devices in Embodiments 1 and 2, including:

a receiving module 301, configured to receive a control signaling for interference processing sent by a base station; and

wherein, the control signaling can in particular be a TDM indication. The control signaling can carry no parameter, and also further may carry a parameter such as a stopping operation type or a logical channel priority.

a stopping module 302, configured to, according to the control signaling, stop a related operation within a non-scheduling period of a communication mode corresponding to the control signaling.

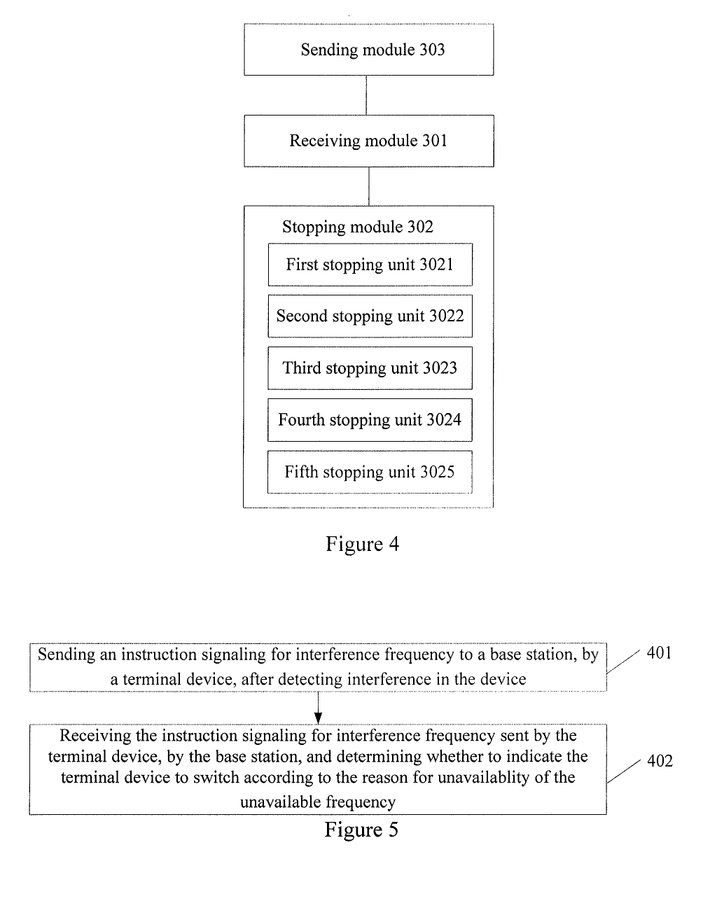

Further, referring to FIG. 4, the terminal device also includes:

a sending module 303, configured to send an instruction signaling for interference frequency to a base station after detecting interference in the terminal device such that the base station returns the control signaling for interference processing when there is no available frequency.

Wherein, the stopping module 302 includes: a first stopping unit 3021, a second stopping unit 3022, a third stopping unit 3023, a fourth stopping unit 3024, or a fifth stopping unit 3025;

the first stopping unit 3021, configured to, according to the control signaling, stop an uplink downlink retransmission operation within the non-scheduling period of the communication mode corresponding to the control signaling;

the second stopping unit 3022, configured to, according to the control signaling, stop an SR triggering operation within the non-scheduling period of the communication mode corresponding to the control signaling;

the third stopping unit 3023, configured to, according to the control signaling, stop an SPS data transmission operation within the non-scheduling period of the communication mode corresponding to the control signaling;

the fourth stopping unit 3024, configured to, according to the stopping operation type carried by the control signaling, stop an operation corresponding to the stopping operation type within the non-scheduling period of the communication mode corresponding to the control signaling;

alternatively, the fourth stopping unit 3024, configured to, according to the control signaling and a subsequent operation instruction carrying a stopping operation type, stop an operation corresponding to the stopping operation type within the non-scheduling period of the communication mode corresponding to the control signaling;

the fifth stopping unit 3025, configured to, according to a scheduling request SR triggering condition carried by the control signaling, stop an SR triggering operation in nonconformity with the SR triggering condition within the non-scheduling period of the communication mode corresponding to the control signaling;

alternatively, the fifth stopping unit 3025, configured to, according to the control signaling, a subsequent operation instruction carrying an SR triggering condition, stop an SR triggering operation in nonconformity with the SR triggering condition within the non-scheduling period of the communication mode corresponding to the control signaling.

Wherein, the SR triggering condition may be a logical channel priority, or a specific service or service type, or radio bearer and etc., and this embodiment is not limited thereto. Particularly, when the SR triggering condition is the logical channel priority, an SR triggering operation of the data with a priority less than the logical channel priority is stopped, and an SR triggering operation of the data with a priority equal to or higher than the logical channel priority is carried out; when the SR triggering condition is the specific service or service type or radio bearer, an SR triggering operation of the specific service or service type or radio bearer is carried out, SR triggering operations of other services or other service types or other radio bearers are stopped; alternatively, the SR triggering operation of the specific service or service type or radio bearer is stopped, and the SR triggering operations of the other services or other service types or other radio bearers are carried out.

Wherein, the first stopping unit 3021 is specifically configured to:

according to the control signaling, stop a DRX retransmission timer of the communication mode corresponding to the control signaling, and clear a Hybrid Automatic Repeat Request HARQ buffer area of the communication mode corresponding to the control signaling.

Wherein, the stopping operation type of the fourth stopping unit 3024 includes: the uplink downlink retransmission operation, the SR triggering operation, or the SPS data transmission operation.

The terminal device provided by this embodiment belong to the same concept with the terminal devices in Embodiments 1 and 2, and the specific implementation processes thereof are described in detail in the method embodiments, and are not discussed further herein.

This embodiment enables other communication modes to carry out data transmission within the non-scheduling period of the communication mode corresponding to the control signaling, by way of stopping by the terminal device a related operation, such as an uplink downlink retransmission operation, the SR triggering operation, the SPS data transmission operation, or the SR triggering operation in nonconformity with the SR triggering condition within the non-scheduling period of the communication mode corresponding to the control signaling according to the control signaling for interference processing sent by the base station. This reduces the interference to the other communication modes due to the communication mode corresponding to the control signaling within the non-scheduling period, and thus reduces interference in the terminal device within the non-scheduling period.

### Embodiment 4

Referring to FIG. 5, this embodiment provides a method for switching frequency, including:

401: sending an instruction signaling for interference frequency to a base station, by a terminal device, after detecting interference in the terminal device;

Wherein, the instruction signaling for interference frequency can at least include an unavailable frequency, and a reason for unavailability of the unavailable frequency, and the instruction signaling may also further include an available frequency. Wherein, the reason for unavailability of the unavailable frequency may in particular be the influence of one system on the other system, such as the influence of LTE on the BT or WiFi. The reason for unavailability can be represented by numbering the scene influenced by the system, for example, the influence of LTE on the BT is numbered as 1, and the influence of LTE on the WiFi is numbered as 2, and so on. In addition, the instruction signaling for interference frequency can be an RRC signaling or a MAC layer signaling.

Wherein, the terminal device may be a UE, but this embodiment is not limited thereto.

402: receiving the instruction signaling for interference frequency sent by the terminal device, by the base station, and determining whether to indicate the terminal device to switch according to the unavailable reason of the unavailable frequency;

Particularly, if the unavailable reason of the unavailable frequency is the influence of the LTE system on other communication mode, then the base station does not indicate the terminal device to switch; if the unavailable reason of the unavailable frequency is the influence of other communication mode on the LTE system and there are available frequencies, the base station can indicate the terminal device to switch to a certain available frequency.

In this embodiment, the base station determines whether to indicate the terminal device to switch according to a reason for unavailability of the unavailable frequency sent by the terminal device, and if the reason for unavailability is the influence of the LTE system on other communication mode, the base station doesn't care about the operating condition of the other communication mode, and if the other communication mode has taken measures to avoid interference and etc, the base station can avoid performing unnecessary switching operations, and thus it saves the processing resources of the base station.

### Embodiment 5

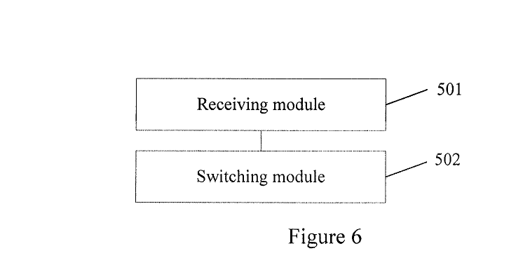

Referring to FIG. 6, this embodiment provides a base station, including:

a receiving module 501, configured to receive an instruction signaling for interference frequency sent by a terminal device after the terminal device detects interference in the terminal device;

Wherein, the instruction signaling for interference frequency can at least include an unavailable frequency, and a reason for unavailability of the unavailable frequency, and the instruction signaling may also further include an available frequency. Wherein, the reason for unavailability of the unavailable frequency may in particular be the influence of one system on the other system, such as the influence of LTE on the BT or WiFi. The reason for unavailability can be represented by numbering the scene influenced by the system, for example, the influence of LTE on the BT is numbered as 1, and the influence of LTE on the WiFi is numbered as 2, and so on. In addition, the instruction signaling for interference frequency can be an RRC signaling or a MAC layer signaling.

a switching module 502, configured to determine whether to indicate the terminal device to switch according to the reason for unavailability of the unavailable frequency carried by the instruction signaling for interference frequency;

The switching module is particularly configured, if the reason for unavailability of the unavailable frequency is the influence of the LTE system on other communication mode, not to indicate the terminal device to switch; if the reason for unavailability of the unavailable frequency is the influence of other communication mode on the LTE system and there are available frequencies, to indicate the terminal device to switch to a certain available frequency.

The base station provided by this embodiment belongs to the same concept with the base station in Embodiment 4, and the specific implementation processes thereof are described in detail in the method embodiment, and are not discussed further herein.

In this embodiment, the base station determines whether to indicate the terminal device to switch according to the reason for unavailability of the unavailable frequency sent by the terminal device, and if the reason is the influence of the LTE system on other communication mode, the base station doesn't care about the operating condition of the other communication mode, and if the other communication mode has taken measures to avoid interference and etc, the base station can avoid performing unnecessary switching operations, and thus it saves the processing resources of the base station.

All or part of the technical solutions provided by embodiments described above can be implemented by software programming, and the software program may be stored on a readable storage media such as a hard disk, an optical disk or a floppy disk in a computer.

The above descriptions are merely preferred embodiments of the present invention and they do not intend to limit the present invention. Any modification, equal replacement and development within the spirit and principle of the present invention shall fall within the protection scope of the present invention.

What is claimed is:

1. A method for reducing interference in a device, comprising:
receiving, by a terminal device, a control signaling for interference processing sent by a base station; and
according to the control signaling, stopping, by the terminal device, a related operation within a non-scheduling period of a communication mode corresponding to the control signaling.

2. The method according to claim 1, before receiving, by a terminal device, the control signaling for interference processing sent by the base station, comprising:
sending, by the terminal device, an instruction signaling for interference frequency to the base station, after detecting interference in the terminal device, such that the base station returns the control signaling for interference processing when there is no available frequency.

3. The method according to claim 1, wherein according to the control signaling, stopping, by the terminal device, the related operation within the non-scheduling period of the communication mode corresponding to the control signaling, comprises:
according to the control signaling, stopping, by the terminal device, an uplink retransmission operation within the non-scheduling period of the communication mode corresponding to the control signaling.

4. The method according to claim 1, wherein according to the control signaling, stopping, by the terminal device, the uplink retransmission operation within the non-scheduling period of the communication mode corresponding to the control signaling, comprises:
according to the control signaling, stopping, by the terminal device, a discontinuous reception(DRX) retransmission timer within the non-scheduling period of the communication mode corresponding to the control signaling.

5. The method according to claim 1, wherein according to the control signaling, stopping, by the terminal device, the related operation within the non-scheduling period of the communication mode corresponding to the control signaling, comprises:
according to the control signaling, stopping, by the terminal device, a downlink retransmission operation within the non-scheduling period of the communication mode corresponding to the control signaling.

6. The method according to claim 5, wherein according to the control signaling, stopping, by the terminal device, the downlink retransmission operation within the non-scheduling period of the communication mode corresponding to the control signaling, comprises:
according to the control signaling, clearing, by the terminal device, a Hybrid Automatic Repeat Request (HARQ) buffer area within the non-scheduling period of the communication mode corresponding to the control signaling.

7. The method according to claim 1, wherein according to the control signaling, stopping, by the terminal device, the related operation within the non-scheduling period of the communication mode corresponding to the control signaling, comprises:
according to the control signaling, stopping, by the terminal device, a scheduling request (SR) triggering operation within the non-scheduling period of the communication mode corresponding to the control signaling.

8. The method according to claim 1, wherein according to the control signaling, stopping, by the terminal device, the related operation within the non-scheduling period of the communication mode corresponding to the control signaling, comprises:
according to the control signaling, stopping, by the terminal device, a semi persistent scheduling (SPS) data transmission operation within the non-scheduling period of the communication mode corresponding to the control signaling.

9. A terminal device, comprising:
a receiver, configured to receive a control signaling for interference processing sent by a base station; and
a processor, configured to, according to the control signaling, stop a related operation within a non-scheduling period of a communication mode corresponding to the control signaling.

10. The terminal device according to claim 9, further comprising:
a transmitter, configured to send an instruction signaling for interference frequency to the base station after detecting interference in the terminal device, such that the base station returns the control signaling for interference processing when there is no available frequency.

11. The terminal device according to claim 9, wherein the processor configured to, according to the control signaling, stop the related operation within the non-scheduling period of the communication mode corresponding to the control signaling, comprises:
the processor configured to, according to the control signaling, stop an uplink retransmission operation within the non-scheduling period of the communication mode corresponding to the control signaling.

12. The terminal device according to claim 11, wherein the processor configured to, according to the control signaling, stop the uplink retransmission operation within the non-scheduling period of the communication mode corresponding to the control signaling, comprises:
the processor configured to, according to the control signaling, stop a discontinuous reception (DRX) retransmission timer within the non-scheduling period of the communication mode corresponding to the control signaling.

13. The terminal device according to claim 9, wherein the processor configured to, according to the control signaling, stop the related operation within the non-scheduling period of the communication mode corresponding to the control signaling, comprises:
the processor configured to, according to the control signaling, stop a downlink retransmission operation within the non-scheduling period of the communication mode corresponding to the control signaling.

14. The terminal device according to claim 13, wherein the processor configured to, according to the control signaling, stop a downlink retransmission operation within the non-scheduling period of the communication mode corresponding to the control signaling, comprises:
the processor configured to, according to the control signaling, clear a Hybrid Automatic Repeat Request (HARQ) buffer area within the non-scheduling period of the communication mode corresponding to the control signaling.

15. The terminal device according to claim 9, wherein the processor configured to, according to the control signaling, stop the related operation within the non-scheduling period of the communication mode corresponding to the control signaling, comprises:
the processor configured to, according to the control signaling, stop a scheduling request (SR) triggering operation within the non-scheduling period of the communication mode corresponding to the control signaling.

16. The terminal device according to claim 9, wherein the processor configured to, according to the control signaling, stop the related operation within the non-scheduling period of the communication mode corresponding to the control signaling, comprises:
The processor configured to, according to the control signaling, stop a semi persistent scheduling (SPS) data transmission operation within the non-scheduling period of the communication mode corresponding to the control signaling.
